(19) United States
(12) Patent Application Publication
(10) Pub. No.: US 2009/0155437 A1
(43) Pub. Date: Jun. 18, 2009

(54) CONTINUOUS SYSTEM FOR PROCESSING PARTICLES

(76) Inventors: George W. Bohnert, Harrisonville, MO (US); Gary M. De Laurentiis, Jamestown, CA (US)

Correspondence Address: Roeder & Broder LLP, 5560 Chelsea Avenue, La Jolla, CA, 92037, US

(21) Appl. No.: 12/334,254

(22) Filed: Dec. 12, 2008

Related U.S. Application Data
(60) Provisional application No. 61/007,584, filed on Dec. 12, 2007.
(60) Provisional application No. 61/036,416, filed on Mar. 13, 2008.

(51) Int. Cl. B08B 3/04; B08B 5/00; A23F 5/16

(52) U.S. Cl. 426/427; 134/32; 134/25.1; 134/18; 134/26; 134/10; 134/21; 134/25.5; 134/30; 134/133; 134/132; 134/58 R

(57) ABSTRACT

A method for removing contaminants from a material (39), such as resin particles, includes the steps of providing a vessel (50), directing a cleaning fluid (41) into the vessel (50), transferring the material into the vessel (50), moving the material within the vessel (50), and removing contaminants from the material as cleaning fluid (41) flows in the vessel (50). The vessel (50) has a vessel inlet (52) and a spaced apart vessel outlet (54). The cleaning fluid (41) is directed into the vessel (50) so that the cleaning fluid (41) flows in the vessel (50). The material (39) is transferred into the vessel (50) through the vessel inlet (52), and the material (39) is then moved within the vessel (50) from the vessel inlet (52) towards the vessel outlet (54). The cleaning fluid (41) flowing in the vessel (50) contacts the material (39) while the material is moving from the vessel inlet (52) toward the vessel outlet (54) and removes contaminants (39) from material (39). The material (39) can be moved substantially continuously within the vessel (50) between the vessel inlet (52) and the vessel outlet (54).

### RELATED APPLICATION

The present application claims priority under 35 U.S.C. §119 on pending U.S. Provisional Application Ser. No. 61/007,584 filed on Dec. 12, 2007 and entitled “Continuous Carbon Dioxide System for Processing Particles”. The present application also claims priority on Provisional Application Ser. No. 61/036,416 filed on Mar. 13, 2008 and entitled “Continuous Carbon Dioxide System for Processing Particles”. As far as is permitted, the contents of Provisional Application Ser. Nos. 61/007,584 and 61/036,416 are incorporated herein by reference.

### GOVERNMENT SPONSORED DEVELOPMENT

The U.S. Government has rights in this invention pursuant to contract number DE-AC04-01AL66850 with the United States Department of Energy.

### FIELD OF THE INVENTION

The invention generally relates to the processing of particles, and more specifically to the exposure of particles to carbon dioxide in a continuous flow system and method.

### BACKGROUND

It is now commonplace for municipalities and waste collection companies to collect plastic bottles and other resin-based packaging material for recycling. Recycling is a highly desired alternative to sending such objects to a landfill where they take up a significant volume of the landfill, do not degrade and breakdown for decades, and also create the possibility that any contaminants present on or in the plastic bottles and other resin-based packaging materials may leak into the surrounding soil and groundwater. Unfortunately, recycling of such materials is often seen as too expensive, too inefficient, and/or too likely to produce additional waste products to encourage people to recycle all of their plastic materials and/or to purchase objects made from recycled plastic materials.

The conventional method of recycling is to grind the bottles and resin into particles and then rinse the particles with water. The problem with this method is that rinsing with water is not very effective. Certain contaminants, such as oils or pesticides, are difficult to remove with water. Often containers made from these plastic bottles and other resin-based packaging materials contain residues of the contaminants they once contained, and if these residues are not removed from the containers, it can greatly decrease the value of the container material for recycling, making the material suitable for only low-grade products. In addition, the water run-off used to clean the resin is also a problem and is harmful to the environment. This water, which typically ends up in lakes, streams or the water table, is often polluted with contaminants, such as oil, chemicals, pesticides, etc. Lastly, the aforementioned recycling process is expensive, and large amounts of water and electricity are consumed during the cleaning process.

Recently a new resin recycling process and system has been developed. With this system, resin flake is cleaned and recycled in a three-stage process. In the initial stage, the resin particles are exposed to a solvent, which substantially removes the contaminant on the resin. In the next stage, the resin particles are separated from the solvent. In the third and final stage, the resin particles are exposed to a solvent removing agent, such as carbon dioxide, in either a supercritical or liquid state, to remove any residual solvent or contaminant remaining on the resin. For more details on this resin recycling process and system, see U.S. Pat. No. 7,253,253 issued to Bohnert et al., incorporated by reference herein for all purposes. This recycling process and system represents a significant improvement over conventional washing with water. Virtually all contaminants are removed from the resin. In addition, with closed-looped solvent wash and carbon dioxide sub-systems, the process is essentially non-polluting, uses no water, and consumes much less electricity relative to conventional water-based recycling.

The aforementioned resin recycling process and system relies on a batch process to expose the resin to the solvent removing agent. After the resin is rinsed and separated from the solvent, it is typically exposed to the solvent removing agent using a batch process. The resin is loaded in a batch process into, one or more machines, similar to a commercial grade washing machine, for agitation and exposure to the solvent removing agent. After the solvent and any residual contaminants are removed, the batch of resin is unloaded from the one or more machines and replaced with a new batch of resin. This process of loading and unloading the resin is repeated, provided there is available resin to process. While highly effective in removing contaminants, the throughput of batch system and method is less than ideal.

An improved system and method to expose particles to carbon dioxide in a continuous flow to increase throughput is therefore needed.

### SUMMARY

The present invention is directed toward a method for removing contaminants from a material. In certain embodiments, the method includes the steps of providing a vessel, directing a cleaning fluid into the vessel, transferring the material into the vessel, moving the material within the vessel, and removing contaminants from the material as cleaning fluid flows in the vessel. The vessel has a vessel inlet and a spaced apart vessel outlet. The cleaning fluid is directed into the vessel so that the cleaning fluid flows in the vessel. The material is transferred into the vessel through the vessel inlet, and the material is then moved within the vessel from the vessel inlet towards the vessel outlet. Contaminants are removed from the material as the cleaning fluid flows in the vessel and contacts the material while the material is moving from the vessel inlet toward the vessel outlet.

In some embodiments, the method includes the step of transferring resin particles into the vessel. In alternative embodiments, the method includes the steps of transferring coffee beans into the vessel and removing caffeine from the coffee beans.

In certain embodiments, the method includes the step of directing carbon dioxide, as the cleaning fluid, into the vessel.

In some embodiments, the method includes the step of controlling at least one property of the cleaning fluid so that at least a portion of the cleaning fluid in the vessel is in a liquid phase and so that at least a portion of the cleaning fluid in the vessel is in a gaseous phase. The step of controlling can include between approximately fifty and ninety percent of the vessel being filled with cleaning fluid in the liquid phase and between approximately ten and fifty percent of the vessel being filled with cleaning fluid in the gaseous phase. In certain embodiments, the step of controlling includes controlling the pressure of the cleaning fluid within the vessel. In one embodiment, the step of controlling includes controlling the pressure of the cleaning fluid near the vessel inlet with an inlet pressurization system and controlling the pressure of the cleaning fluid near the vessel outlet with an outlet pressurization system. The pressurization systems are connected with a bypass line and a compressor.

In certain embodiments, the step of providing the vessel includes inclining the vessel between the vessel inlet and the vessel outlet.

In some embodiments, the step of moving the material within the vessel includes rotating a helical flighting positioned in the vessel. In certain embodiments, the step of moving the material includes substantially continuously moving the material within the vessel between the vessel inlet and the vessel outlet. In one embodiment, the step of transferring includes transferring the material into the vessel in batches, while the material is substantially continuously moved within the vessel between the vessel inlet and the vessel outlet. In another embodiment, the method further includes the step of removing the material from the vessel though the vessel outlet in batches.

In certain embodiments, the step of moving the material includes moving the material within the vessel through a cleaning fluid wash zone, a clean cleaning fluid rinse zone, and a cleaning fluid drain zone. In one such embodiment, the material is moved within the vessel progressively through the cleaning fluid wash zone, the clean cleaning fluid rinse zone, and the cleaning fluid drain zone.

In some embodiments, the step of directing includes directing the cleaning fluid into the vessel at a fluid inlet that is located intermediate the vessel inlet and the vessel outlet. In one embodiment, the method further includes the step of removing the cleaning fluid from the vessel near the vessel inlet. In certain embodiments, the method further includes the step of cleaning the cleaning fluid, wherein the cleaned cleaning fluid is directed into the vessel. In one such embodiment, the cleaned cleaning fluid is directed into the vessel so that it flows within the vessel from the fluid inlet toward the vessel inlet. In this embodiment, the step of moving the material includes progressively exposing the material to cleaner cleaning fluid as the material moves within the vessel from the vessel inlet towards the fluid inlet.

In certain embodiments, the vessel can be a conduit through which the material is moved from the vessel inlet towards the vessel outlet, and through which the cleaning fluid flows from the fluid inlet toward the vessel inlet. In one such embodiment, the vessel is shaped like an elongated tube with the vessel inlet near a first end of the tube and the vessel outlet near a second end of the tube.

In some embodiments, the step of transferring includes transferring the material into the vessel from a feeder. In one such embodiment, the method further includes the step of excluding air from entering the vessel by providing a gas blanket near a bottom of the feeder, wherein the gas blanket is formed from a gas that is heavier than air.

In certain embodiments, the steps of directing fluid and moving the material include the fluid flowing relative to the movement of the material in the vessel. In one such embodiment, the fluid flows in a substantially opposite direction to the movement of the material in the vessel.

In some embodiments, the method further includes the step of washing the material with a solvent prior to transferring the material into the vessel through the vessel inlet.

In yet another embodiment, the present invention is directed to a material cleaning system for removing contaminants from a material. In this embodiment, the material cleaning system includes a vessel, a material source that transfers the material into the vessel, a material mover that moves the material within the vessel, and a cleaning fluid source that directs a cleaning fluid into the vessel so that cleaning fluid flows in the vessel. The vessel includes a vessel inlet and a spaced apart vessel outlet, and the material source transfers the material into the vessel through the vessel inlet. The material mover moves the material within the vessel and through the cleaning fluid from the vessel inlet toward the vessel outlet.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic view of a material cleaning system having features of the present invention;

FIG. 2 is a simplified schematic view of a removal station having features of the present invention;

FIG. 3 is a simplified schematic view of a feeder and an inlet pressurization system having features of the present invention; and

FIG. 4 is a simplified schematic view of an outlet pressurization system having features of the present invention.

### DESCRIPTION

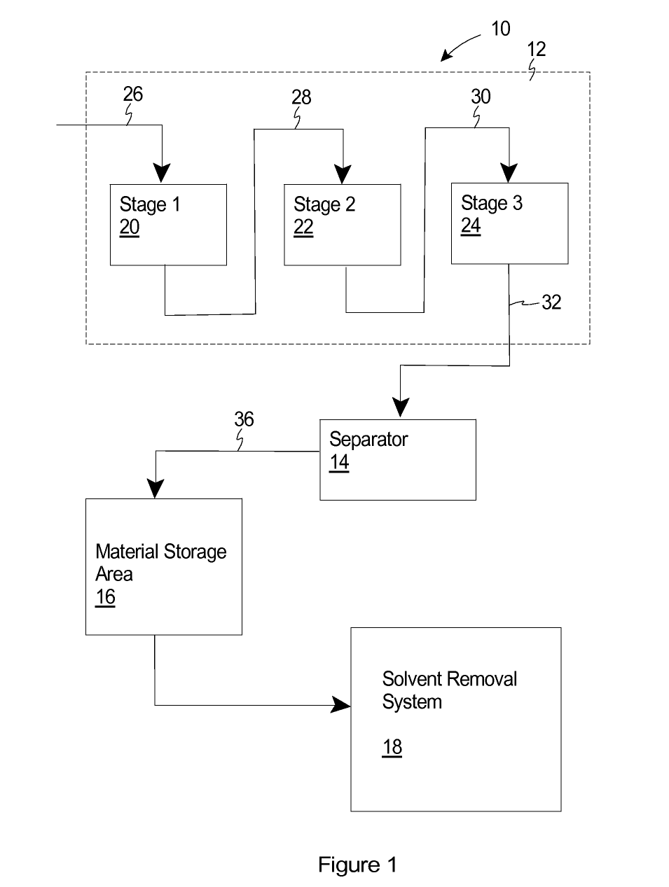

FIG. 1 is a simplified schematic view of a material cleaning system 10 having features of the present invention. The material cleaning system 10, as discussed in detail below, has been primarily designed to be utilized for removing contaminants from the resin of post-consumer containers and other objects made from resin material. Typically, the resin material is shredded or ground into approximately ⅜-inch particles or flakes (sometimes referred to herein as “resin particles”) before being introduced into the material cleaning system 10. Alternatively, one or more of the processes disclosed herein can be utilized in other procedures, such as removing caffeine from coffee beans, or removing contaminants or other unwanted material from types of material.

The material cleaning system 10 is particularly useful in the removal of oil, pesticides, milk, soda water, detergents, soaps, and other consumer materials commonly sold or otherwise distributed in resin packaging from high-density polyethylene, HDPE, and polyethylene terepthalate, or any other type of resin containers. In addition, the cleaning system 10 is also suitable for removing polychlorinated biphenyl (PCB) contaminants particularly from automotive plastics. Additionally, the material cleaning system 10 is highly effective in removing labels and label adhesive from synthetic resin material containers. Further, the material cleaning system 10 facilitates contaminant recovery from synthetic resin materials, thereby enabling the contaminants to be disposed of in a safe and environmentally friendly manner.

As illustrated in FIG. 1, the material cleaning system 10 includes a contaminant removal system 12 where a majority of the contaminants are removed from the resin material using a cleaning solvent (e.g. ethyl lactate or another cleaning solvent); a separator 14; a material storage area 16; and a solvent removal system 18 that removes the remaining solvent and contaminants from the material. It should be noted that the solvent removal system 18 is also sometimes referred to as a material cleaning system.

As an overview, the unique material cleaning system 10 provided herein enables a less time-consuming, more cost-effective and more efficient process for removing contaminants from a material by providing a system that removes cleaning solvents and other contaminants from the synthetic resin material in a substantially continuous process, thereby increasing throughput.

As illustrated in FIG. 1, the contaminant removal system 12 includes a first contaminant removal stage 20, a second contaminant removal stage 22, and a third contaminant removal stage 24. The specific design of the contaminant removal system 12 can be varied. A suitable contaminant removal system 12 is described in U.S. Pat. No. 7,253,253 issued to Bohnert et al., the contents of which are incorporated herein by reference.

In the embodiment shown, resin particles, illustrated as feed stream 26, are initially loaded into the first contaminant removal stage 20, which contains a liquid solvent. In the first contaminant removal stage 20, the resin particles are vigorously mixed with the solvent. Thereafter, the resin particles, illustrated as stream 28, are transferred to the second contaminant removal stage 22. The second contaminant removal stage 22 operates in a very similar manner to the first contaminant removal stage 20 in that the resin particles are mixed with additional quantities of solvent. After the second contaminant removal stage 22, the resin particles, illustrated as stream 30, are transferred to the third contaminant removal stage 24. Again, the third contaminant removal stage 24 is similar in operation to the first two contaminant removal stages 20, 22.

In alternative embodiments, the contaminant removal system 12 can be designed with less than three contaminant removal stages 20, 22, 24. For example, resin particles can be exposed in either a single stage or two stages. In another embodiment, the system 12 may include only a single stage, and the resin particles are exposed to a solvent in one or more solvent washes in that single stage. In yet other embodiments, more than three stages 20, 22, and 34 may be used. Regardless of the number of stages or the number of times the resin is exposed to solvent, in each embodiment, the resin is exposed to a solvent, resulting in the removal of most if not all of the contaminants on the particles.

After the solvent wash, regardless of the number of stages used, the resin particles, illustrated as stream 32, are then sent to the separator 14, where a substantial portion of the solvent is separated from the resin particles. In one embodiment, the separator 14 employs a device, such as a spin dryer, to mechanically separate the solvent from the resin particles.

In yet other embodiments, a closed loop solvent recovery system may be used so that the contaminants that collect in the solvent may be removed from the solvent. Periodically the solvent used in the stages 20, 22, and 23 is removed and the solvent collected at the separator 14 is either filtered or distilled to remove the contaminants. The cleaned solvent can then be reused, while the contaminants are collected in one location for safe and environmentally disposal.

Once a substantial portion of the solvent has been separated from the resin particles in the separator 14, the resin particles, with any remaining solvent, are transferred to the material storage area 16 via stream 36 where it is held until it is ready to be further cleaned in the solvent removal system 18. In alternative embodiments, the material cleaning system 10 can be designed without the material storage area 16. In such embodiments the resin particles are transferred directly from the separator 14 to the solvent removal system 18.

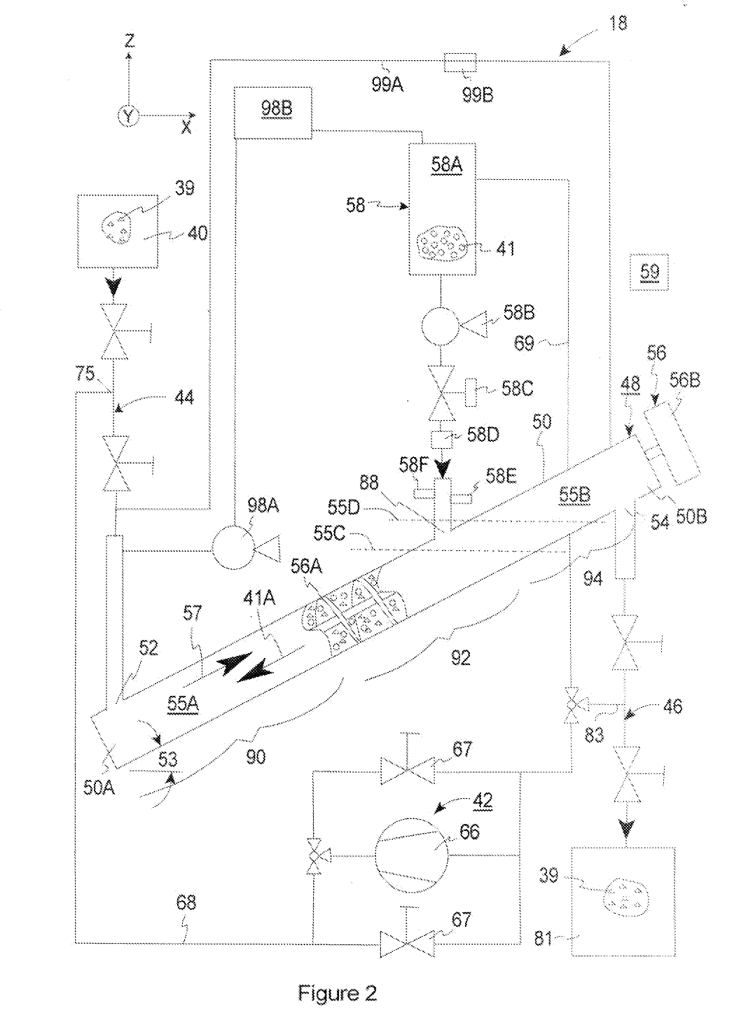

FIG. 2 is a simplified illustration of one embodiment of a removal system 18 having features of the present invention in partial cutaway. The specific design of the removal system 18 can be varied depending on the requirements of the material 39 (illustrated as small triangles) that is being cleaned. For example, the system 18 described herein is particularly useful for removing solvents from synthetic resin particles 39.

As provided herein, the removal system 18 utilizes a substantially continuous flow process that allows for the removal of the cleaning solvents from the particles 39 in a relatively quick, more cost-effective, and more efficient process, thereby improving throughput. This reduces the cost for cleaning the resin material 39, and increases the likelihood that the resin material 39 will be recycled instead of being discarded to a landfill. Further, the removal system 18 can recycle a cleaning fluid 41 (illustrated as small circles) used to clean the material 39. This further reduces the environmental impact of recycling of the resin material 39.

Alternatively, the removal system 18 of the present invention can be utilized in other processes, such as removing caffeine from coffee beans, or removing contaminants from another type of material.

As illustrated in FIG. 2, the removal system 18 includes: (i) a feeder 40 (sometimes also referred to as a material source); (ii) a pressure equalization system 42, (iii) an inlet pressurization system 44, (iv) an outlet pressurization system 46; (v) a transport system 48 including a vessel 50 having a vessel inlet 52 and a vessel outlet 54, and a material mover 56; (vi) a cleaning fluid supply system 58 that supplies the cleaning fluid 41 to the vessel 50 and controls the characteristics of the fluid 41 in the vessel 50, and (vii) a control system 59 (e.g. one or more processors) that controls the operation of one or more these components. The design of each of these components can be varied to suit the material 39 being cleaned and the required level of cleaning of the material 39.

In one embodiment, the cleaning fluid 41 utilized herein is a solvent removing fluid, such as carbon dioxide. Alternatively, a different cleaning fluid 41 can be used, such as saturated aliphatic hydrocarbons, unsaturated aliphatic hydrocarbons, saturated cyclic hydrocarbons, unsaturated cyclic hydrocarbons, aromatic hydrocarbons. Additional controls may be required to use flammable and/or combustible fluids as the cleaning fluid 41.

The feeder 40 is adapted to receive the resin particles 39, or other material, from the material storage area 16 (illustrated in FIG. 1). Alternatively, the feeder 40 can be utilized to receive the resin particles 39 directly from the separator 14 (illustrated in FIG. 1) and hold the resin particles 39 for further processing without the use of a separate material storage area 16. The feeder 40 then transfers the resin particles 39 through the inlet pressurization system 44 into the vessel 50 through the vessel inlet 52.

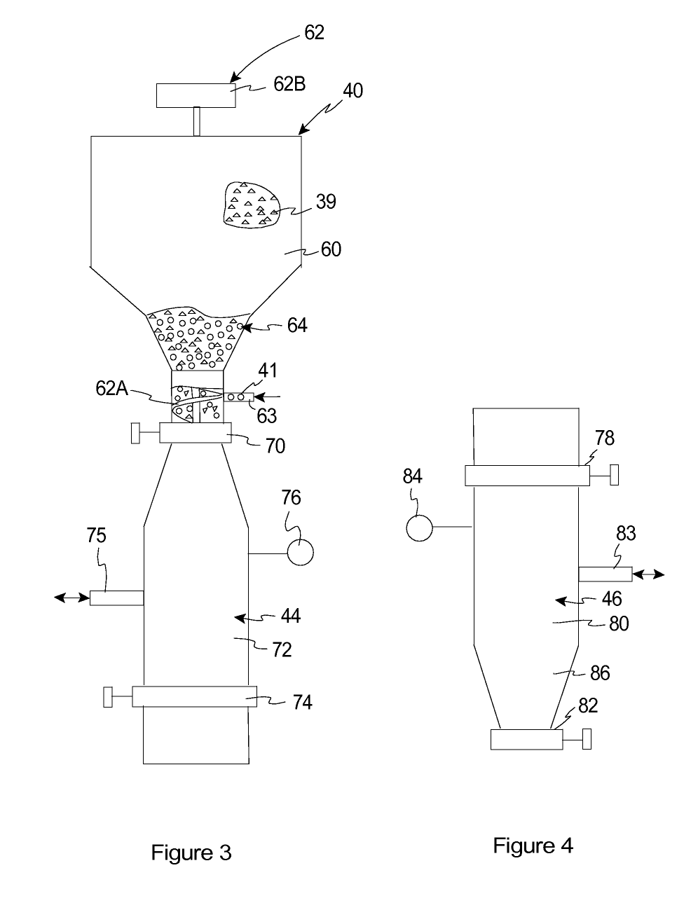

FIG. 3 is a more detailed illustration of the feeder 40 and the inlet pressurization system 44 in partial cut-away. In this embodiment, the feeder 40 includes a vented feed bin 60, a feeder mover 62, and an optional gas blanket 64. The vented feed bin 60 is designed to hold a certain volume of the resin particles 39 before they are transferred to the vessel 50 (illustrated in FIG. 2) via the inlet pressurization system 44. For example, in one non-exclusive embodiment, the vented feed bin 60 can be designed to hold between approximately four to six cubic feet of the resin particles 39. Alternatively, the vented feed bin 60 can be designed to hold a greater or lesser amount of resin particles 39.

The feeder mover 62 moves the resin particles 39 in the feeder 40 to the bottom of the vented feed bin 60 from where the resin particles 39 can free fall into the inlet pressurization system 44, when opened, through the force of gravity. In one non-exclusive example, the feeder mover 62 can include a feeder helical flighting 62A (e.g. an auger), and a feeder motor 62B that rotates the helical flighting 62.

In an optional embodiment, a gas blanket 64 may be established or formed near the bottom of the feeder 40 by injecting a small amount of fluid 41 (illustrated as small circles) into a fluid inlet 63 into the feeder 40 near the bottom of the feeder 40 to exclude air from the inlet pressurization system 44. The gas blanket 64 can be made using the cleaning fluid 41 (e.g. carbon dioxide gas) bleed from the fluid supply system 58 (illustrated in FIG. 2). The carbon dioxide 41 is somewhat heavier than the air that is present in the top of the vented feed bin 60. As a result thereof, the carbon dioxide 41 settles to the bottom of the vented feed bin 60 near the area of the feeder auger 62A where it establishes the gas blanket 64. The resin particles pass through the carbon dioxide gas blanket 64 before entering the inlet pressurization system 44. Accordingly, air can be purged from the particles 39 prior to the particles 39 entering the inlet pressurization system 44. In yet another optional alternative embodiment, the gas blanket 64 can be formed with a fluid 41 other than carbon dioxide, so long as the gas that is utilized is heavier than the air that is present in the vented feed bin 60.

The inlet pressurization system 44 provides an inlet chamber 72 for receiving the resin particles 39 that are at approximately atmospheric pressure from the feeder 40, and subsequently, the pressure in the inlet chamber 72 is raised to closely approximate and match the pressure inside the vessel 50 so that the particles 39 can be injected into the vessel inlet 52 without lowering the pressure in the vessel 50. For example, the inlet pressurization system 44 is designed to bring the resin particles 39 from atmospheric pressure to an operating pressure of approximately 800 psi.

Additionally, the inlet chamber 72 can include a tubular shaped body, an inlet entrance valve 70, an inlet exit valve 74, and a fluid inlet 75 that is in fluid communication with the pressurization equalization system 42 (illustrated in FIG. 2). In this embodiment, the inlet entrance valve 70 defines the top of the inlet chamber 72, and the inlet exit valve 74 defines the bottom of the chamber 72.

The inlet entrance valve 70 controls when the resin particles 39 can be moved (e.g. fall in orientation of FIG. 3) into the inlet equalization chamber 72. Due to the inclusion of the feeder mover 62 within the feeder 40, a much smaller inlet entrance valve 70 may be possible. For example, a 4 inch or 6 inch full port valve may be possible for the inlet entrance valve 70. Utilizing a small inlet entrance valve 70 such as suggested makes it possible for provide a significant valve cost reduction. Alternatively, a different size may be used for the inlet entrance valve 70.

The inlet exit valve 74 controls the movement of the resin particles 39 from the inlet equalization chamber 72 to the vessel 50. In one non-exclusive embodiment, the inlet exit valve 74 may be a 12-inch full port valve. Alternatively, a different size may be used for the inlet exit valve 74.

The inlet equalization chamber 72, in one non-exclusive embodiment, is designed to hold a predetermine amount of resin particles 39 (e.g. approximately 70 pounds of resin particles), or other material (5 cubic feet volume @ 80% fill loading and a plastic bulk density of 17 pounds per cubic foot). The inlet equalization chamber 72 is equipped with a level sensor 76 that monitors the volume of material in the inlet equalization chamber 72. For example, for a one-foot diameter inlet equalization chamber 72, a length of 6.5 feet (excluding the transition zone) of pipe is needed for a volume of five cubic feet. This assumes the inlet equalization chamber 72 can cycle from atmospheric pressure to 800 psi and back in one minute.

Although, as discussed above, in one embodiment, the inlet chamber 72 of the inlet pressurization system 44 is designed to operate with a pressure of approximately 800 psi, a slight overpressure of 5 to 10 psi (making the total pressure in the inlet chamber 72 approximately 805 to 810 psi) may be utilized to assist in transferring the resin particles 39 into the vessel 50 through the vessel inlet 52.

With this design, at the start of the process, the inlet exit valve 74 is closed, the pressurization equalization system 42 has reduced the pressure in the inlet chamber 72 to approximately atmospheric pressure, and the inlet entrance valve 70 is opened. At this time, the particles 39 are free to be moved (e.g. free fall via gravity in the orientation of FIG. 3) into the inlet chamber 72. Subsequently, after the level sensor 76 indicates that the inlet chamber 72 is full, the inlet entrance valve 70 is closed and the pressurization equalization system 42 is used to raise the pressure in the inlet chamber 72 to approximately match (or slightly above) that of the pressure in the vessel 50. Next, the inlet exit valve 74 is opened and the particles 39 are moved (e.g. free fall via gravity in the orientation of FIG. 3) into the vessel 50 at the vessel inlet 52. After the particles 39 have moved from the inlet chamber 72 to the vessel 50, this process is repeated to move batches of the particles 39 into the vessel 50 in a semi-continuous process.

FIG. 4 is a simplified illustration of the outlet pressurization system 46. As provided herein, the outlet pressurization system 46 provides an outlet chamber 80 for receiving the resin particles 39 (illustrated in FIG. 2) from the vessel outlet 54 (illustrated in FIG. 2) that are at approximately the same pressure as inside the vessel 50 (illustrated in FIG. 2), and subsequently, the pressure in the outlet chamber 80 is lower to closely approximate and match the atmospheric pressure. For example, the outlet pressurization system 46 can be designed to bring the resin particles 39 from the operating pressure of approximately 800 psi to approximately atmospheric pressure.

In one embodiment, the outlet chamber 80 can include an outlet entrance valve 78, an outlet exit valve 82, and a fluid inlet 83 that is in fluid communication with the pressurization equalization system 42 (illustrated in FIG. 2). In this embodiment, the outlet entrance valve 78 defines the top of the outlet chamber 80, and the outlet exit valve 82 defines the bottom of the outlet chamber 80.

The outlet entrance valve 78 controls the flow of the resin particles 39 as they are moved (e.g. free fall via gravity in the orientation of FIG. 4) from the vessel outlet 54 (illustrated in FIG. 2) of the vessel 50 into the outlet chamber 80. In one non-exclusive embodiment, the outlet entrance valve 78 may be a 12-inch full port valve. Alternatively, a different size may be used for the outlet entrance valve 78.

The outlet exit valve 82 controls the movement of the resin particles 39 out of the outlet chamber 80. In certain embodiments, a conical shaped bottom outlet 86 and a slight overpressure in the outlet equalization chamber 80 can be utilized. In these embodiments, a smaller outlet exit valve 82 may be possible. For example, a 4 inch or 6 inch full port valve may be possible for the outlet exit valve 82. Utilizing a small outlet exit valve 82 such as suggested makes it possible for provide a significant valve cost reduction. Alternatively, a different size may be used for the outlet exit valve 82.

The outlet equalization chamber 80 can be similar to the inlet equalization chamber 72, and can be designed to hold approximately 70 pounds of resin particles, or other material (5 cubic feet volume @ 80% fill loading and a plastic bulk density of 17 pounds per cubic foot). The outlet equalization chamber 80 is also equipped with a level sensor 84 that monitors the volume of material in the outlet equalization chamber 80. For a one-foot diameter outlet equalization chamber 80, a length of 6.5 feet (excluding the transition zone) of pipe is needed for a volume of five cubic feet. This assumes the outlet equalization chamber 80 can cycle from atmospheric pressure to 800 psi and back in one minute. The outlet equalization chamber 80 may also include a conical bottom outlet 86.

Although the outlet equalization chamber 80 is designed to operate at approximately atmospheric pressure, a slight overpressure of 5 to 10 psi may be utilized to assist in transferring the resin particles 39 out of the outlet chamber 80 into a material recovery bin 81 (illustrated in FIG. 2).

With this design, at the start of the process, the outlet exit valve 82 and the outlet entrance valve 78 are closed, and the pressurization equalization system 42 increases the pressure in the outlet chamber 80 to approximately match that of the vessel 50. Next, the outlet entrance valve 78 is opened. At this time, the particles 39 are moved (e.g. free fall via gravity in the orientation of FIG. 4) into the outlet chamber 80. Subsequently, after the level sensor 84 indicates that the outlet chamber 80 is full, the outlet entrance valve 78 is closed and the pressurization equalization system 42 is used to lower the pressure in the outlet chamber 80 to approximately match (or slightly above) the atmospheric pressure. Next, the outlet exit valve 82 is opened and the particles 39 are moved (e.g. free fall via gravity in the orientation of FIG. 4) out of the outlet chamber 80 to the material recovery bin 81. After the particles 39 have moved from the outlet chamber 80, this process is repeated to remove the particles 39 in batches from the vessel 50 is a semi-continuous process.

Because of the use of the inlet pressurization system 44 and the outlet pressurization system 46, the solvent laden particles 39 (that started at atmospheric pressure) can be moved/injected into the pressurized vessel 50 in batches, and the clean particles 39 removed from the pressurized vessel 50 and brought to atmospheric pressure in batches, without reducing the pressure in the vessel 50. This allows the particles 39 to be cleaned in a semi-continuous fashion.

Referring back to FIG. 2, the pressurization equalization system 42 is utilized to control the pressures in the inlet pressurization system 44 and the outlet pressurization system 46. Stated in another fashion, the pressurization equalization system 42 sequentially cycles the pressure in the inlet pressurization system 44 to allow for the input of the particles 39 into the vessel, and sequentially cycles the pressure in the outlet pressurization system 46 to allow for the removal of the particles 39 from the vessel 50, all while maintaining the pressure within the vessel substantially constant.

In one embodiment, the pressurization equalization system 42 includes a compressor 66, a plurality of valves 67, and a connector line 68 that connects (i) the pressure equalization system 42 to the fluid inlet 75 of the inlet pressurization system 44 and (ii) the pressure equalization system 42 to the fluid inlet 83 of the outlet pressurization system 46. Additionally, the pressurization equalization system 42 is in fluid communication via conduit 69 with the fluid source 58.

As provided herein, the inlet pressurization system 44 and the outlet pressurization system 46 can be initially equalized so that the pressure in each system 44, 46 is approximately 400 psi. At that point, the compressor 66 moves the fluid 41 between the outlet pressurization system 46 and the inlet pressurization system 44, so that the inlet pressurization system 44 ultimately reaches approximately 800 psi and the outlet pressurization system 46 ultimately reduces to approximately atmospheric pressure. Subsequently, the compressor 66 can move the fluid 41 between the inlet pressurization system 44 and the outlet pressurization system 46, so that the outlet pressurization system 46 ultimately reaches approximately 800 psi and the inlet pressurization system 44 ultimately reduces to approximately atmospheric pressure. This process is repeated to introduce batches of the dirty particles 39 into the vessel 50 and remove batches of clean particles 39 from the vessel 50.

The design of the transport system 48 can be varied depending upon the requirements of the removal system 18. In the embodiment illustrated in FIG. 2, the transport system 48 includes (i) the vessel 50 having the vessel inlet 52, the spaced apart vessel outlet 54, and a fluid inlet 88 that is located intermediate of the vessel inlet 52 and the vessel outlet 54, and (ii) the material mover 56 that moves the resin particles 39 through the vessel 50 from the vessel inlet 52 to the vessel outlet 54. The system 18 is designed so that the resin particles 39 are further cleaned within the vessel 50 to remove any remaining contaminants and substantially all of the solvent from the resin particles 39, or other material.

The vessel 50 is designed to receive the resin particles 39 from the inlet pressurization system 44 through the vessel inlet 52, move the particles 39 through the cleaning fluid 39, and transfer the resin particles 39 to the outlet pressurization system 46 through the vessel outlet 54. In one embodiment, the vessel 50 is shaped similar to an elongated, cylindrical tube. In this embodiment, the elongated tube includes the vessel inlet 52 that is positioned near a bottom, first end 50A of the tube, and the vessel outlet 54 that is positioned near a top, second end 50B of the tube. Alternatively, the vessel 50 can have a different shaped conduit that transports the particles 39.

In certain embodiments, the vessel 50 (e.g. the tube) is inclined relative to horizontal at a vessel angle 53 between the vessel inlet 52 and the vessel outlet 54. In one non-exclusive embodiment, the vessel 50 is inclined at a vessel angle 53 of between approximately 20-50 degrees from the vessel inlet 52 to the vessel outlet 54. Alternatively, the vessel 50 can be inclined more than fifty degrees or less than twenty degrees from the vessel inlet 52 to the vessel outlet 54.

In certain embodiment, this inclination of the vessel 50 allows for the properties of the fluid 41 to be controlled to be a liquid in a lower first section 55A of the vessel 50 (near the vessel inlet 52), and a gas towards an upper second section 55B of the vessel 50 (near the vessel inlet 54). With this design, the particles 39 can be initially moved through the liquid (e.g. carbon dioxide) fluid 41 to clean the particles 39 and subsequently through the gaseous (e.g. carbon dioxide) fluid 41 to dry the particles 39. Alternatively, for example, the cleaning fluid 41 can be a supercritical carbon dioxide fluid that is injected into the vessel 50. With this design, the cleaning fluid 41 can be controlled to stay in only one phase throughout the vessel 50 during the cleaning process.

The material mover 56 is designed to move the resin particles 39 through the vessel 50 from the vessel inlet 52 to the vessel outlet 54 in a material movement direction 57 (indicated as an arrow). In certain embodiments, the material mover 56 includes a helical flighting 56A (e.g. an auger), that is positioned in the vessel 50, and a material motor 56B that rotates the helical flighting 56A to move the resin particles 39 through the vessel 50 from the vessel inlet 52 to the vessel outlet 54. With this design of the material mover 56, the particles 39 and fluid 41 are in an agitated state and the particles 39 and the fluid 41 are aggressively mixed. This enhances the cleaning the particles 39.

Alternatively, the material mover 56 can have a different design and/or have a different mode of operation.

The cleaning fluid supply system 58 supplies the cleaning fluid 41 into the vessel 50 and controls one or more properties of the cleaning fluid 41 in the vessel 50 to control the state of the cleaning fluid 41 in the vessel. In certain embodiments, the pressure and/or temperature are controlled so that at least a portion of the cleaning fluid 41 that is present in the vessel 50 is in a liquid phase and so that at least a portion of the cleaning fluid 41 that is present in the vessel 50 is in a gaseous phase. For example, the pressure and/or temperature can be controlled so that between approximately fifty to ninety percent of the vessel 50 is filled with cleaning fluid 41 in the liquid phase, and so that between approximately ten to fifty percent of the vessel 50 is filled with cleaning fluid 41 in the gaseous phase.

In certain embodiments, the pressure and/or temperature of the fluid 41 are controlled by the fluid supply system 58 so that the fluid is a liquid in the lower first section 55A of the vessel 50, and a gas towards the upper second section 55B of the vessel 50. In FIG. 2, (i) dashed line 55C represents the area of the vessel 50 below which the fluid 41 is a liquid, (ii) dashed line 55D represents the area of the vessel 50 above which the fluid 41 is a liquid, and (iii) the fluid 41 is a liquid/gas mixture between dashed lines 55C, 55D.

The fluid supply system 58 directs the cleaning fluid 41 into the vessel 50 through the fluid inlet 88. In one embodiment, the fluid inlet 88 is located between the vessel inlet 52 and the vessel outlet 54, and the fluid inlet 88 is closer to the vessel outlet 54 than the vessel inlet 52. Further, the fluid supply system 58 removes the cleaning fluid 41 from the vessel inlet 52. With this design, clean cleaning fluid 41 is continuously being injected into the vessel 50 and dirty cleaning fluid 41 is continuously removed from the bottom of the vessel 50.

Further, with this design, the cleaning fluid 41 flows from the fluid inlet 88 down to the vessel inlet 52 in a fluid flow direction 41A (as indicated by arrow). As discussed above, during operation, the material mover 56 moves the resin particles 39, through the vessel 50 from the vessel inlet 52 to the vessel outlet 54 in material movement direction 57. Thus, the particles 39 are moved in the substantially opposite direction to the fluid 39 in the vessel 50. With this design, as the particles 39 are becoming continuously cleaner in the vessel 50, the particles 39 are subjected to cleaner cleaning fluid 41.

Moreover, as a result of this design, there are three approximate zones within the vessel 50, namely a cleaning fluid wash zone 90 (located near the vessel inlet 52), a clean cleaning fluid rinse zone 92 (located near the fluid inlet 88), and a cleaning fluid drain zone 94 (located near the vessel outlet 54). As provided herein, the relatively dirty resin particles 39 are initially moved through the cleaning fluid wash zone 90 where a significant portion of any remaining contaminants and the solvent are removed from the resin particles 39. The relatively cleaner resin particles 39 then leave the cleaning fluid wash zone 90 and pass through the clean cleaning fluid rinse zone 92 where the resin particles 39 receive a final rinse of clean cleaning fluid 41 (that has just entered the vessel 50 from the fluid inlet 88). The clean cleaning fluid 41 rinse lowers the concentration of solvent remaining on the resin particles 39, thereby ultimately producing a cleaner material. Finally, the resin particles 39 enter the cleaning fluid drain zone 94 where any liquid cleaning fluid 41 is drained or separated from the resin particles 39. After being processed through the cleaning fluid drain zone 94, the resin particles 39, and a small amount of gaseous cleaning fluid 39, are then transferred out of the vessel 50 through the vessel outlet 54 into the outlet pressurization system 46.

In certain embodiments, (i) the fluid 41 in the vessel 50 is a liquid in the fluid wash zone 90 and the clean cleaning fluid rinse zone 92, and (ii) the fluid 41 is a gas in the cleaning fluid drain (beach) zone 94. In yet other embodiments, the pressure and temperature in the vessel 50 can be controlled so that the fluid 41 is maintained in a supercritical form in the vessel 50.

In one embodiment, the fluid source 58 includes a fluid tank 58A that retains the fluid 41, a fluid pump 58B that pumps the fluid 41, a pressure regulator 58C that regulates the pressure of the fluid 41 entering the vessel 48, a temperature regulator 58D that regulates the temperature of the fluid 41 entering the vessel 48, a pressure measurer 58E that measures the pressure of the fluid 41 entering the vessel 48, and a temperature measurer 58F that measures the temperature of the fluid 41 entering the vessel 48. With this design, the properties of the fluid 41 can be controlled so that a portion of the fluid 41 in the vessel 50 is a liquid and a portion of the fluid 41 in the vessel 50 is a gas.

Additionally, the fluid supply system 58 can include a pump 98A that pulls the dirty cleaning fluid 41 from the vessel inlet 52 and a cleaning unit 98B that cleans the dirty cleaning fluid 41. Subsequently, the clean fluid 41 from the cleaning unit 98B can be returned to the storage tank 58A. With this design, the cleaning fluid 41 can be recycled to make the system 18 more environmentally friendly. Thus, the cleaning fluid supply system 58 can be a closed-loop system including the steps of: (i) directing the cleaning fluid 41 from the cleaning fluid storage tank 100 into the vessel 50 through the fluid inlet 88; (ii) directing the cleaning fluid 41 from the fluid inlet 88 toward the vessel inlet 52 and the fluid outlet 96; (iii) removing the cleaning fluid 41 from the vessel 50 through the fluid outlet 96; (iv) transferring the cleaning fluid 41 to the cleaning unit 98B wherein the cleaning fluid is cleaned and distilled; and (v) returning the cleaned cleaning fluid 41 to the storage tank 58A.

For example, the cleaning unit 98B can distill the dirty cleaning fluid 41 to clean this fluid 41. The cleaning unit 98B can be designed for distilling approximately 20 gallons of cleaning fluid 41 per minute. In certain embodiments, when carbon dioxide is chosen as the operable cleaning fluid 41, the total cooling load for carbon dioxide condensing is 610,000 BTUs per hour. Clean carbon dioxide can gravity drain from the cleaning unit 98B into the storage tank 58A. Steam load to the cleaning unit 98B can be approximately 620 pounds per hour. Automatic discharge of the solvent laden cleaning unit 98B bottoms to a blow down tank (not shown) will prevent excessive concentration of solvent build up in the cleaning unit 98B. Plate type heat transfer surfaces are being considered for evaporation and condensing.

In one embodiment, the system 18 also includes a pressure equalization conduit 99A and a relief valve 99B that connects the second end 50B of the vessel 50 in fluid communication with the vessel inlet 52 of the vessel. With this design, the pressure equalization conduit 99A keeps the pressure equalized between these two locations.

In one non-exclusive embodiment, the system 18 is designed to process approximately 4,080 pounds of resin particles 39, or other material, per hour. To achieve this level of processing, the vessel 50 can be a tube that has an inner diameter of approximately 1 foot, or 0.785 cubic feet per linear foot (0.753 for schedule 80 pipe). In one embodiment, to allow the resin particles 39 to remain in the cleaning fluid wash zone 90 for approximately 5 minutes, the portion of the vessel 50 that contains cleaning fluid 41 in the liquid phase and makes up the cleaning fluid wash zone 90 will need to be approximately 26 feet in length. This assumes that 4 cubic feet of resin particles are conveyed through the vessel 50 each minute. The clean cleaning fluid rinse zone 92 is designed to be approximately 3 to 4 feet in length where clean cleaning fluid is added into the vessel 50 through the fluid inlet 88. The final cleaning fluid drain zone 94, or liquid/solid separation zone (beach), of the vessel 50 is designed to be approximately 10 feet in length, so that the resin particles 39 and gas only will be transferred to the outlet pressurization system 46. Accordingly, the vessel 50, in certain embodiments, can have a total length of approximately 40 feet. Alternatively, each successive zone 90, 92, 94 and the total vessel 50 can be designed to be different lengths depending on the specific requirements of the material cleaning system 10 and the solvent removal system 18. Still alternatively, the transport system 48 can be designed to process greater than 4,080 pounds or less than 4,080 pounds of resin particles, or other material, per hour.

While the current invention is disclosed in detail herein, it is to be understood that it is merely illustrative of certain embodiments of the invention. For example, the pressure in the vessel may range from five hundred and five (505) to one thousand and sixty-nine (1069) pounds per square inch absolute, and the temperature may range from thirty-two (32) to eighty-seven (87) degrees Fahrenheit for a system that utilizes liquid/gas carbon dioxide as the cleaning fluid 41. Further, the system and method may also be used to remove caffeine and other contaminants from coffee beans. In this embodiment, the operation of the system would essentially be the same with the beans introduced and removed from the vessel 50 in batches, while continuously flowing from the vessel inlet to the vessel outlet while being exposed to the carbon dioxide cleaning fluid. With this embodiment, the pressure and temperature within the vessel 50 can be controlled for the optimization of the de-caffeination process. In no way should any of the specifics described herein be construed as limiting. Rather, the scope of the invention should be defined commensurate with the appended claims.

What is claimed is:

1. A method for removing contaminants from a material, the method comprising the steps of:
providing a vessel having a vessel inlet, and a spaced apart vessel outlet;
directing a cleaning fluid into the vessel so that the cleaning fluid flows in the vessel;
transferring the material into the vessel through the vessel inlet;
moving the material within the vessel from the vessel inlet toward the vessel outlet; and
removing contaminants from the material as cleaning fluid flows in the vessel and contacts the material while the material is moving from the vessel inlet toward the vessel outlet.

2. The method of claim 1 wherein the step of transferring the material into the vessel includes the step of transferring resin particles into the vessel.

3. The method of claim 1 wherein the step of transferring the material into the vessel includes the step of transferring coffee beans into the vessel, and wherein the step of removing contaminants includes the step of removing caffeine from the coffee beans.

4. The method of claim 1 wherein the step of directing includes the step of directing carbon dioxide into the vessel.

5. The method of claim 1 further comprising the step of controlling at least one property of the cleaning fluid so that at least a portion of the cleaning fluid in the vessel is in a liquid phase and so that at least a portion of the cleaning fluid in the vessel is in a gaseous phase.

6. The method of claim 5 wherein the step of controlling includes controlling at least one property so that between approximately fifty to ninety percent of the vessel is filled with cleaning fluid in the liquid phase, and so that between approximately ten to fifty percent of the vessel is filled with cleaning fluid in the gaseous phase.

7. The method of claim 5 wherein the step of controlling includes the step of controlling the pressure of the cleaning fluid within the vessel.

8. The method of claim 5 wherein the step of controlling includes the steps of controlling the pressure of the cleaning fluid near the vessel inlet with an inlet pressurization system, and controlling the pressure of the cleaning fluid near the vessel outlet with an outlet pressurization system, and wherein the pressurization systems are connected with a bypass line and a compressor.

9. The method of claim 1 wherein the step of providing a vessel includes the step of inclining the vessel between the vessel inlet and the vessel outlet.

10. The method of claim 1 wherein the step of moving includes the step of rotating a helical flighting positioned in the vessel.

11. The method of claim 1 wherein the step of moving includes the step of substantially continuously moving the material within the vessel between the vessel inlet and the vessel outlet.

12. The method of claim 1 wherein the step of transferring includes the step of transferring the material into the vessel in batches, and wherein the step of moving includes the step of substantially continuously moving the material within the vessel between the vessel inlet and the vessel outlet.

13. The method of claim 12 further including the step of removing the material from the vessel through the vessel outlet in batches.

14. The method of claim 1 wherein the step of moving includes the step of moving the material within the vessel through a cleaning fluid wash zone, a clean cleaning fluid rinse zone, and a cleaning fluid drain zone.

15. The method of claim 1 wherein the step of moving includes the step of moving the material within the vessel progressively through a cleaning fluid wash zone, a clean cleaning fluid rinse zone, and a cleaning fluid drain zone.

16. The method of claim 1 wherein the step of directing the cleaning fluid includes directing the cleaning fluid into the vessel at a fluid inlet that is located intermediate the vessel inlet and the vessel outlet.

17. The method of claim 16 further comprising the step of removing the cleaning fluid from the vessel near the vessel inlet.

18. The method of claim 17 further comprising the step of cleaning the cleaning fluid removed from the vessel, and wherein the step of directing the cleaning fluid includes the step of directing the cleaned cleaning fluid into the vessel.

19. The method of claim 18 wherein the step of directing cleaned cleaning fluid includes the step of directing cleaned cleaning fluid into the vessel so that it flows within the vessel from the fluid inlet toward the vessel inlet.

20. The method of claim 19 wherein the step of moving the material includes the step of progressively exposing the material to cleaner cleaning fluid as the material moves within the vessel from the vessel inlet towards the fluid inlet.

21. The method of claim 1 wherein the step of transferring the material includes the step of transferring the material into the vessel from a feeder, and further including the step of excluding air from entering the vessel by providing a gas blanket near a bottom of the feeder, wherein the gas blanket is formed from a gas that is heavier than air.

22. The method of claim 1 further including the step of washing the material with a solvent prior to the step of transferring the material into the vessel through the vessel inlet.

23. The method of claim 1 wherein the steps of directing fluid and moving the material includes the fluid flowing relative to the movement of the material in the vessel.

24. The method of claim 1 wherein the steps of directing fluid and moving the material includes the fluid flowing in a substantially opposite direction to the material movement in the vessel.

25. The method of claim 1 wherein the step of providing a vessel includes the step of providing a vessel shaped like an elongated tube with the vessel inlet near a first end of the tube and the vessel outlet near a second end of the tube.

26. A method for removing contaminants from a material, the method comprising the steps of:
providing a vessel having a vessel inlet, a spaced apart vessel outlet, a first portion, and a second portion;
directing a cleaning fluid into the vessel so that the cleaning fluid is in a gaseous phase in the first portion and in a liquid phase in the second portion of the vessel;
transferring the material into the vessel through the vessel inlet; and
moving the material within the vessel and through the cleaning fluid from the vessel inlet towards the vessel outlet with a material mover so that the material is moved through the cleaning fluid in the liquid phase in the first portion and the gaseous phase in the second portion.

27. A method for removing one or more solvents from resin particles, the method comprising the steps of:
providing a vessel having a vessel inlet, and a spaced apart vessel outlet;
continuously directing a solvent removing fluid into the vessel;
transferring the resin particles into the vessel through the vessel inlet;
moving the resin particles within the vessel from the vessel inlet to the vessel outlet and through the solvent removing fluid; and
transferring the resin particles from the vessel through the vessel outlet.

28. A material cleaning system for removing contaminants from a material, the material cleaning system comprising:
a vessel having a vessel inlet and a spaced apart vessel outlet;
a material source that transfers the material into the vessel through the vessel inlet;
a cleaning fluid source that directs a cleaning fluid into the vessel so that the cleaning fluid flows in the vessel; and
a material mover that moves the material within the vessel and through the cleaning fluid from the vessel inlet toward the vessel outlet.

29. The material cleaning system of claim 28 wherein the material includes at one or resin particles or coffee beans.

30. The material cleaning system of claim 28 wherein the cleaning fluid is carbon dioxide.

31. The material cleaning system of claim 28 further comprising a controller that controls at least one property of the cleaning fluid so that at least a portion of the cleaning fluid in the vessel is in a liquid phase and so that at least a portion of the cleaning fluid in the vessel is in a gaseous phase.

32. The material cleaning system of claim 31 wherein the controller controls at least one property of the cleaning fluid so that between approximately fifty and ninety percent of the cleaning fluid in the vessel is in a liquid phase and so that between approximately ten and fifty percent of the cleaning fluid in the vessel is in a gaseous phase.

33. The material cleaning system of claim 28 wherein the vessel is inclined between the vessel inlet and the vessel outlet.

34. The material cleaning system of claim 28 wherein the material mover includes a helical flighting positioned in the vessel.

35. The material cleaning system of claim 28 wherein the material source transfers the material into the vessel in batches, wherein the material mover substantially continuously moves the material within the vessel between the vessel inlet and the vessel outlet, and wherein the material is removed from the vessel through the vessel outlet in batches.

36. The material cleaning system of claim 28 wherein the material mover moves the material within the vessel progressively through a cleaning fluid wash zone, a clean cleaning fluid rinse zone, and a cleaning fluid drain zone.

37. The material cleaning system of claim 28 wherein the cleaning fluid source directs cleaning fluid into the vessel so that it flows within the vessel towards the vessel inlet, and wherein the material mover progressively exposes the material to cleaner cleaning fluid as the material moves within the vessel from the vessel inlet towards the vessel outlet.

38. The material cleaning system of claim 28 wherein the cleaning fluid flows in a substantially opposite direction to the material within in the vessel.

39. The material cleaning system of claim 28 wherein the vessel is shaped like an elongated tube with the vessel inlet near a first end of the tube and the vessel outlet near a second end of the tube.
